(19) United States
(12) Patent Application Publication
(10) Pub. No.: US 2002/0159678 A1
(43) Pub. Date: Oct. 31, 2002

(54) Optical switch for routing signals and a network incorporating same

(75) Inventors: Stylianos Derventzis, North York (CA); Steve Hill, Toronto (CA); Blaine Hobson, King City (CA); Ali Langari, Scarborough (CA); Mike Liwak, Pickering (CA); Robert B. Thayer, Painted Post, NY (US)

Correspondence Address: HOFFMANN & BARON, LLP, 6900 JERICHO TURNPIKE, SYOSSET, NY, 11791, US

(73) Assignee: Photonami Inc.

(21) Appl. No.: 10/091,161

(22) Filed: Mar. 5, 2002

(30) Foreign Application Priority Data
Mar. 9, 2001 (CA) 2,340,148

(51) Int. Cl. G02B 6/35; G02B 6/26

(52) U.S. Cl. 385/16; 385/15

(57) ABSTRACT

An optical switch for routing optical signals is disclosed. The optical switch has an optical signal path for routing said optical signals between at least a first port and at least a second port, wherein said optical signal path is divided into two portions with one portion being defined by at least two switch expansion modules; and the other portion being defined by a distribution backplane for operatively connecting the switch expansion modules together. An optical switching network is also disclosed having optical signal paths which intersect in at least two switch nodes, the network having at least two switches for switching optical signals, wherein one of the switches is located at each of the switch nodes and each of the switches includes at least two switch expansion modules and an optical backplane for connecting the switch expansion modules together. The switch modules from each of the switches are configured to permit the switch modules from either switch to be used interchangeably to complete optical switching in the other.

### FIELD OF THE INVENTION

This invention relates generally to the field of optical communication devices and more particularly to devices of the type which switch optical signals and signal components such as individual wavelength bands. More particularly this invention relates to switches which are capable of routing selected signals or signal components from one port to another port as needed as well as to networks including such switches at network nodes.

### BACKGROUND OF THE INVENTION

In the recent past advances in optical signal processing have led to an increased use of optical signals to carry information. Optical signals are now multiplexed together (referred to as DWDM) and sent through fibre optic systems. However to deliver any information to any particular end-user requires that the end destination be connected to the pertinent stream of data. To deliver the right information to an end-user requires that the right signal component or components be connected to the end-user.

This connection has typically been done by way of an optical-electrical-optical (OEO) conversion, in which the signal routing or switching has occurred in the electrical stage. More recently, various forms of all optical switch have been proposed to permit the direct connection of optical signals and signal components without the need for the electrical conversion step. However, to date the all optical solutions developed have all had drawbacks of one form or another.

One of the problems associated with network switching is the need to add additional capacity in the future to accommodate increased traffic or to accommodate additional lines being connected to the switch due to infilling of the network. At present the switches are custom designed for a specific number of connections (hence ports) and there is little scalability available in such designs. Essentially once a switch is installed, it has a fixed and unchangeable switching capacity. Additional lines therefore require new switches.

Current optical routers, such as those based on MEMS technologies, use signal demultiplexers prior to the routing or switching portion of the switch. Thus, between each port of the switch and the routing section (sometimes referred to as a switching array) the demultiplexed signal requires as many individual signal paths and signal path connections as there are signal components in the multiplexed signal to begin with. Then each path of each signal component must be routable to the appropriate signal path for every other port. However, each signal path is typically only routable between only one of two possible output connections. Thus, for a multi port switch multiple switching or routing arrays are required which increases the costs.

The optical signals are degraded with each routing step and thus passing a signal through multiple signal switching arrays can require signal rehabilitation, which can also add to the expense. Also, the greater the number of signal components in any given multiplexed signal the greater the number of signal paths required in any given array and the greater the difficulties in alignment. The larger the size of each array, the larger the overall switch is with all the necessary switching arrays.

What is needed is a simpler switch architecture which does not rely on moving parts and which is flexible in design to accommodate growth in switching or network routing demand.

### SUMMARY OF THE INVENTION

An object of the present invention is to provide an all optical switch or router for switching optical signals without the need for an electrical conversion. Such a device should be capable of selecting individual signal components from a multiplexed signal and directing the appropriate signal component to a predetermined destination, such as an outlet port. Most preferably such a device would be of simple construction and would be relatively inexpensive to build, without moving parts. What is further required is an internal switch architecture that permits the device to connect an incoming signal or signal component from any incoming port with any outgoing port. What is further required is a device that has an internal architecture that facilitates the same and which permits a switching capacity adapted to meet the specific needs of a particular node in a network as the network demand requires. Thus, for a low traffic node, the switch provides routing for only a select few signal components. Conversely, for a high volume traffic load the device provides high volume switching capacity. As well, the switch architecture permits components to be upgraded to improve capacity without requiring the replacement of the whole switch.

Therefore there is provided according to the present invention an optical switch for routing optical signals, said optical switch comprising:

an optical signal path for routing said optical signals between at least a first port and at least a second port, wherein said optical signal path is divided into two portions,

one portion being defined by at least two switch expansion modules; and

the other portion being defined by an optical backplane for operatively connecting said at least two switch expansion modules together.

Further, there is also provided, according to the present invention, an optical switching network having optical signal paths which intersect in at least two switch nodes, said network comprising:

at least two switches for switching optical signals, and one located at each of said switch nodes, each of said switches including at least two switch expansion modules and an optical backplane for connecting the switch modules together, wherein the switch modules from each of said switches are functionally configured to permit said switch modules from either switch to be used interchangeably to complete optical switching in the other.

### BRIEF DESCRIPTION OF THE DRAWINGS

Reference will now be made to various drawings which, by way of example only illustrate preferred embodiments of the present invention and in which:

FIG. 1 is a first embodiment of a switch architecture according to the present invention;

FIG. 2 is a schematic view of one form of signal selector according to the present invention;

FIG. 3 is a second embodiment of a switch architecture according to the present invention;

FIG. 4 is a third embodiment of a switch architecture according to the present invention;

FIG. 5 is one embodiment of general switch expansion module configuration according to the present invention second embodiment;

FIG. 6 is an embodiment of a backplane corresponding to the general module of FIG. 5;

FIG. 7a is a schematic view of a network comprised of switches according to the present invention at a time TO;

FIG. 7b is a schematic view of the network of FIG. 7a at a later time T1, showing the growth of the network; and

FIG. 7c is a schematic view of the network of FIGS. 7a and 7b at a further later time T2.

### DETAILED DESCRIPTION OF THE PREFERRED EMBODIMENTS

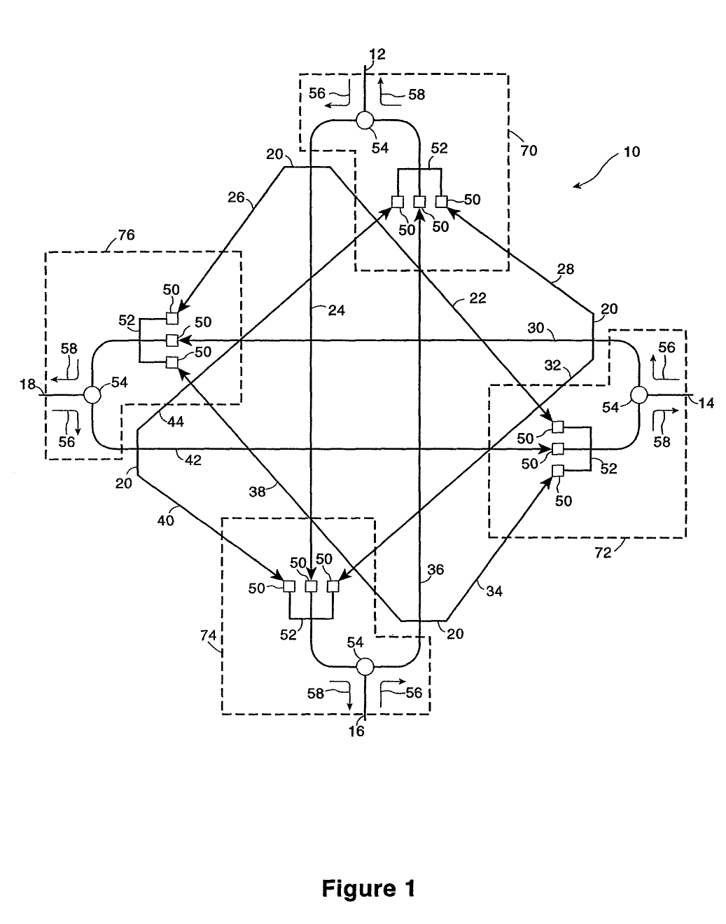

A switch architecture is shown at 10 in FIG. 1 according to a preferred embodiment of the present invention. The switch architecture 10 includes a number of individual elements as follows. There are a number of ports 12, 14, 16, and 18. It will be understood that four are depicted in FIG. 1 by way of example only and that the present invention comprehends switch architectures having either more or fewer ports. In this sense a port means a connection to a source of optical signals which may be for example a fibre optic network cable carrying DWDM optical signals.

In this disclosure the term optical signal means any multiplexed form of optical signal. While the following specification concentrates on frequency division multiplexing, the present invention also comprehends other forms of multiplexing such as time division multiplexing (TDM). An optical signal according to the present invention is comprised of one or more optical signal components representing individual wavelengths and/or channels and may for example take the form of information-carrying bands of light. Such bands of light are often referred to in the art as wavelengths. The sizes of the individual wavelength bands tend to shrink as the technologies improve, thereby allowing even more information to be carried. Thus, this invention comprehends that the DWDM signals comprised of individual wavelength bands and TDM channels on an individual wave band, without being limited to any specific wavelength band size or time slot of such bands.

In FIG. 1, the ports 12, 14, 16 and 18 are bidirectional, meaning that signals and signal components may pass through any port in either direction, that is, either through any given port into the switch, or through any given port out of the switch, both simultaneously or sequentially. As will be understood by those skilled in the art, other configurations for the external connections for the switch 10 are comprehended by the present invention, and for example, may include 1, 2 or many fibres to be connected to the device 10. However, in all such cases the functionality of the switch architecture as describe below, namely to receive and distribute signals is still required.

The switch of the present invention preferably performs several important functions. The sequence of the functions can vary, and such variations in function sequence will affect the efficiency of the design and the architecture of the switch. In the design of FIG. 1, the signal is first replicated, for example, through a splitter 20, to provide at least one informationally identical copy of any given multiplexed signal for every other port of the switch. Thus, for an N equals four (a four port switch), (N−1) or three copies are made. In this sense an informationally identical copy of a signal is one that has the same information content, but one which may be at a different power or through appropriate amplification at the same or even higher power as the original signal. A preferred way to make the copies is to use the splitter 20 but other ways of copying the signal are also comprehended. Thus, on the way into the switch the signals are split into N−1 identical signals and on the way out of the switch the signals are combined into a single signal. In the example of FIG. 1 with four ports the signals are split into three informationally identical signals by the splitter 20.

Each of the three informationally identical signals emerging from a splitter 20 is then routed along a separate signal path. Each signal path extends between the incoming port and each of the other ports of the switch. Thus, any signal received at any individual port is available at every other port. In FIG. 1, signal paths 22, 24, and 26 extend between port 12 and ports 14,16 and 18 respectively. For the other three ports there are similar signal paths which are noted as 28, 30 and 32 originating from port 14; 34, 36 and 38 originating from port 16; and 40, 42 and 44 originating from port 18. The signal paths are shown with arrows that denote the direction that signals are propagated along the signal paths.

Between any given input port and any given output port a number of additional steps are required for signal routing. It will be noted that unlike prior art devices which are separated into input and output planes, the present invention comprehends that any given port can act as an input or an output port at any time. For example, although a full multiplexed signal received through any port is available to every other port by reason of the foregoing architecture, it is likely that only part of the signal, in the form of one or more signal components, needs to be routed to and out any other port. Thus, it is necessary to engage in a signal selection step between the input and output ports. This occurs in the signal selectors, shown schematically as boxes 50 in FIG. 1. The signal selectors 50 are explained in more detail below.

Once the selected signals have been passed through the signal selector 50, then the signals are routed to the output port to be sent back out over the transmission system of the network. First however, the signals from each of the other ports must be combined into a single signal. This is done by means of a combiner 52. Thus, associated with each of the ports is a combiner 52 to combine the selected signals selected from each of the other ports. In this sense, selected means that the signals are permitted to pass through the signal selection step and can then be passed out of the switch through the adjacent port which becomes for that instant an output port.

It can now be appreciated that at each port therefore there is the possibility at any time of signals passing into and out of the port simultaneously. To permit any incoming signals to be separated from any outgoing signals, a circulator 54 is provided at each port. The circulator 54 is preferably a three-node circulator and functions so that signals received at any given node are passed out the next adjacent node. Thus, signals entering into the switch 10 from port 12 encounter the circulator 54 and are directed to the splitter 20 as shown by arrow 56. Selected signals leaving the switch 10 enter the circulator 54 and are passed out of the port 12 as shown by the arrow 58. Similar arrows 56 and 58 are shown at each of the other ports 14, 16 and 18. Other external port configurations are comprehended as noted previously.

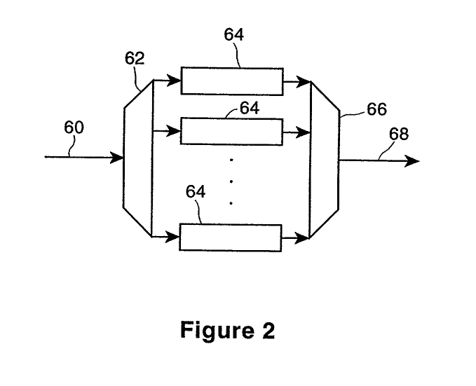

FIG. 2 shows one of the signal selection devices 50 of FIG. 1 in more detail. The incoming signal path is shown as 60. Then the signal is fed into a demultiplexer 62, which separates the signal into individual signal components which as noted previously are bands of light having a predetermined frequency width. The individual signal components are then passed through selection elements 64 that can, for example, either pass or substantially block the individual signal components separately. In this manner signal components can be selected or deselected according to the desired routing. A controller will control selection and de-selection, and thus will be responsible for routing the signals through the switch. The selected signal components can then be multiplexed together in multiplexer 66 and directed to the appropriate output port, along signal path 68.

It will be understood by those skilled in the art that various forms of demultiplexer/multiplexer can be used, such as prisms, diffraction gratings, arrayed waveguides (AWGS) and the like. Most preferred however is a form of demultiplexer/multiplexer that reliably separates the signal into signal components in one direction and reliably multiplexes the signal components into signal in the other direction with a minimum of power loss or signal distortion. Further, a form of multiplexer demultiplexer that separates the signals into broader bands than individual signal components is comprehended by the present invention.

By way of example, the present C-band ITU grid comprises wavelengths from 1530 to 1563 nm, which encompasses about 42 wavelengths at a spacing of about 100 Ghz. The signal selectors according to the present invention can be configured to operate on the full bandwidth of 42 or more signal components, on a specific sub-band, or on any wavelength or wavelength band as a unit. For example, the band may be broken up into a number of discrete units (assuming for the sake of the example 100 Ghz spacing). A signal selector may be configured to demultiplex all 40 plus signals, only the first sixteen and the next sixteen, five groups of eight, ten groups of four, or any other selection of groups including all or part of the signal component bandwidth. Thus at one extreme, a single selection can be used to control the whole band from one port to another. The other extreme is a signal component selector for each separate signal component in the signal.

One of the current limitations to building optical networks is the high cost of the various components needed to provide the switching, including multiplexers/demultiplexers. An advantage of using signal selectors capable of selecting larger groupings of signal bandwidth is that the number of components needed can be reduced with an attendant reduction in cost for the overall switch. Of course such a reduced cost comes at the price of reduced control over signal selection.

The present invention also comprehends various alternative ways of selecting and deselecting signal components. One form of signal selector 64 is a variable optical attenuator (VOA). One form of variable optical attenuator changes opacity in response to an applied electrical field. Thus by selectively applying the field, the attenuator will either permit the passage of the signal component or substantially block the same. Each signal component, or band of signal components can therefore be permitted to pass or can be blocked, as needed, for switching purposes. The present invention comprehends various types of signal selectors, which may be mechanically, thermally, optically, electrically or otherwise initiated to change from a selecting state in which a signal is permitted to pass to a deselecting state in which enough of a signal is blocked, scattered, attenuated or otherwise dispersed to prevent further signal manipulation. At present the most preferred type of signal selection provides about 30 dB or more contrast ratio between selected signals and deselected signals, in a time frame that permits suitable routing connections to be made.

Returning to FIG. 1 it can be seen that there are ghost outlined areas 70, 72, 74 and 76, which can now be explained. According to the present invention the ghost areas 70, 72, 74 and 76 correspond to switch expansion modules. Thus, one preferred form of the invention is to locate the elements encompassed by the ghost areas onto a number of modules and to provide the remaining part of the switch 10 on a single backplane element. Thus the present invention comprehends separating the components of the switch architecture 10 into two sets. One set comprises a number of substantially identical modular elements which are referred to as switch expansion modules and the other comprises a single element that is called a distribution backplane. Each of these elements has separate functions as set out in more detail below.

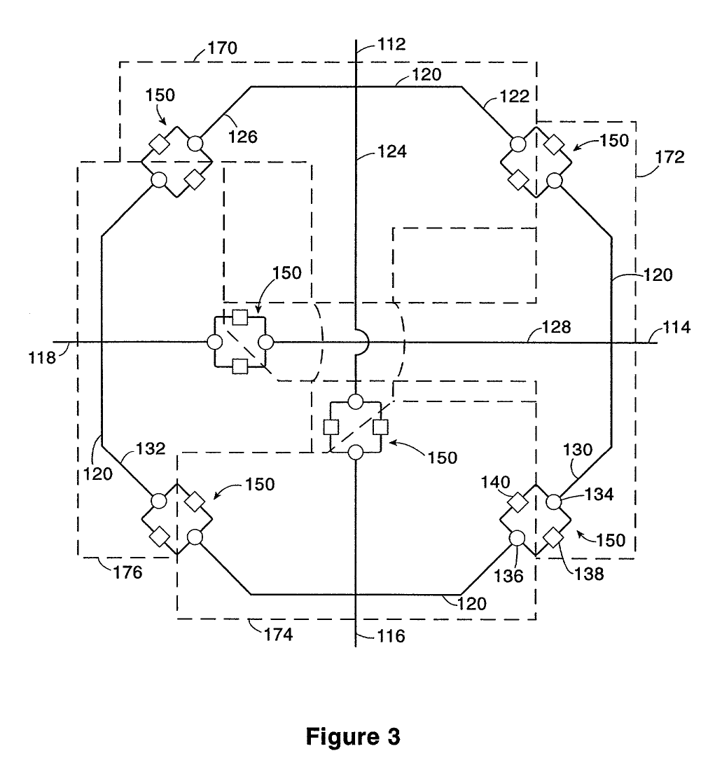

Turning now to FIG. 3 a further embodiment of the present invention is disclosed. In the embodiment of FIG. 3, a slightly different switch architecture is presented, but this further architecture also shares the same advantage as the first embodiment, namely that the switch can be divided into a backplane and a plurality of individual plug-in switch modules. In FIG. 3 a further four port switch is shown, with ports 112, 114, 116 and 118. At each port is a splitter/combiner shown as 120. Signals may pass into or out of any port. Each port is connected to each other port by means of a signal path. Thus, port 112 is connected to ports 114,116 and 118 by means of signal paths 122, 124, and 126. Other signal paths are shown at 128,130 and 132. It will be noted that in this embodiment only one signal path exists between each port and thus, each such signal path is bidirectional.

Located on each signal path is a bi-directional signal selector shown as 150. Each of these are substantially identical and each includes a first circulator 134 and a second circulator 136. Also shown are two signal selectors 138 and 140. The signal selectors are of the type described above, namely of the type that demultiplexes a DWDM signal, selects the signal components to be passed and substantially blocks the rest. The circulators 134, 136 are also of the same type as previously described, namely, they are three node circulators. Thus, the signals travelling in one direction are directed to the signal selector 134 and signals travelling in the other direction are directed to signal selector 136. Thus selection and de-selection of signals or signal components can be made in either direction to permit the desired information carrying signals to be routed from one port to the other.

The advantage of the switch architecture of this embodiment is that there are fewer signal paths required, as compared to that of FIG. 1. However, a disadvantage is that this architecture requires twice as many circulators, which are expensive components. The ghost lines of FIG. 3 show the division of this architecture into expansion modules 170, 172, 174, and 176 and a distribution backplane. The backplane is much simpler and consists of single interconnects.

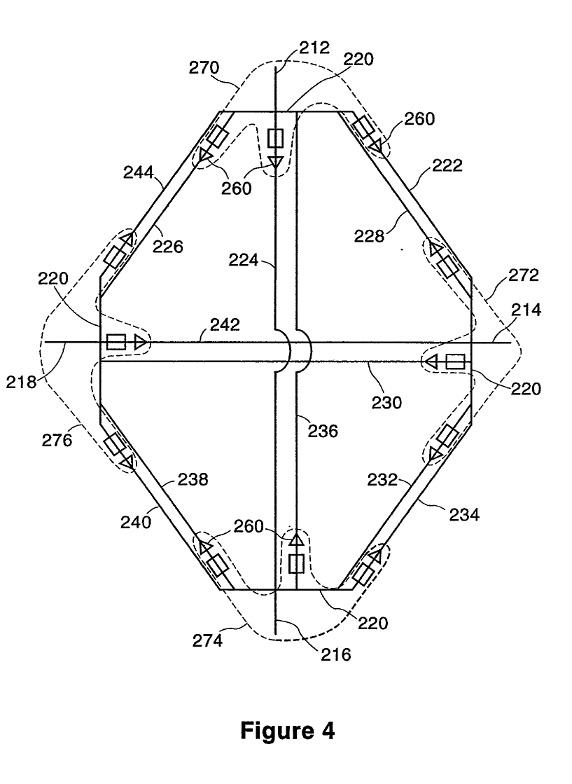

FIG. 4 shows yet a further embodiment of a switch architecture according to the present invention. In this architecture, the circulators on bidirectional signal paths have been replaced with two unidirectional signal paths with associated isolators. As shown there are ports 212, 214, 216, and 218. Associated with each port is a six way splitter/combiner, each of which is shown as 220. Extending from each splitter 220, are three signal paths to each of the other three ports. Thus, extending from the port 212 are signal paths 222, 224, and 226 to ports 214, 216 and 218 respectively. For the other three ports there are similar signal paths which are noted as 228, 230 and 232 originating from port 214; 234, 236 and 238 originating from port 216; and 240, 242 and 244 originating from port 218. The signal paths are shown with isolators 260 which prevent signals from being propagated along the signal paths in a direction opposite to the desired direction, to prevent signal mixing.

It can now be appreciated that the embodiment of FIG. 4 is similar to that of FIG. 1 except that rather than using a circulator at each port and a pair of three way splitter/combiners, this embodiment uses a six way splitter combiner 220 at each port with associated isolators 260 to prevent signal mixing in the lines. Thus, the cost saving provided by eliminating the use of circulators at each port is offset by the lower signal power of the routed signals due to a six way split and subsequent combine as opposed to a three way split and subsequent combine. Because each split and combine step causes a power loss in the signal, more amplification is required for the embodiment of FIG. 4. Thus, the trade off for eliminating the circulators is greater amplification and the difficulties associated with routing weaker signals.

Shown is ghost outline in FIG. 4 are individual switch modules 270, 272, 274, and 276. Thus, as with both the embodiment of FIG. 1 and FIG. 3 this embodiment is dividable into a distribution backplane and associated switch expansion modules 270, 272, 274, and 276 which are operatively connected by the backplane.

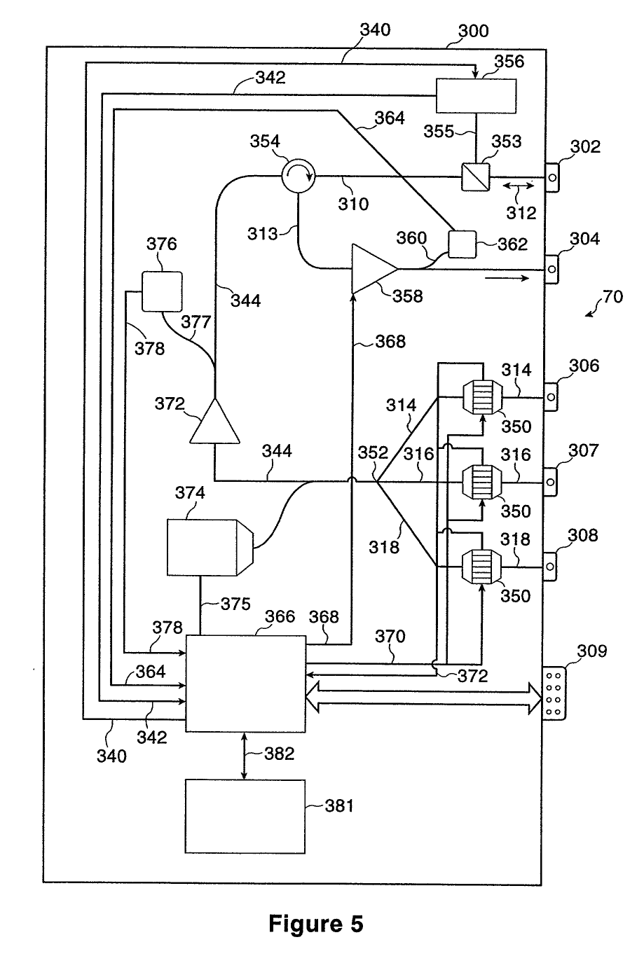

FIG. 5 is a schematic view of one embodiment of a representative switch expansion module 70 for an N=4 switch by way of example only, and in particular as an example of a module suitable for a switch as shown in FIG. 1. The module includes signal paths for both optical signals and electrical signals. The electrical signal paths are used for control and monitoring. The optical signals remain as optical signals following the optical signal paths. In the preferred form the switch expansion module includes a substrate 300 with optical connectors 302, 304, 306, 307 and 308. Also provided is an electrical node bus connector 309. The substrate may be in any form and in essence simply provides a body onto which the various components described hereafter may be mounted.

Turing first to the optical signal paths, extending between the connector 302 and the circulator 354, is a path 310. As indicated by the double-ended arrow 312 optical signals can travel along this section of the signal path in both directions. This path leads from an optical connection to the backplane, which in turn optically connects the path to a port on the switch. It will be appreciated by those skilled in the art that port connection may also be made directly to the switch expansion module 70, rather than through the backplane, provided that the port connection is still operatively connected to the switch expansion module to permit optical signals to pass between the port and the switch expansion module. However, connection of the ports to the backplane is preferred because then if a switch expansion module is to be replaced or removed, disconnecting and reconnecting is somewhat simpler.

Extending between the circulator 354 and the optical connector 304 is a signal path 313. Multiplexed optical signals passing into the switch 10 are directed by the circulator 354 down the signal path 313. This signal path is unidirectional and directs signals further into the switch 10.

As the signal enters the module along signal path 310, it encounters an optical signal channel add/drop 353 which separates out an optical supervising channel (OSC) for communication between nodes or switches in the network. Thus, the optical supervisory channel is sent along signal path 355, to a transceiver 356, where the signal is then read. Transceiver 356 is connected by means of electrical lines 340 and 342 to a micro controller 366 which is explained in more detail below. For signals to be sent out of the node and thus travelling in the reverse direction an OSC wavelength can be added. This can be electronically controlled either at the port or at the node level.

After passing through the circulator 354, the optical signal travelling along signal path 313 is preferably optically amplified, before it is sent through the backplane. It will be understood that the present invention comprehends that optical amplification can take place at a number of places, either internal to the switch or even external depending upon network design and the like. Associated with the preferred amplifier 358 is an electrical based power monitoring circuit including electrical signal path 360, power monitor 362 and further electrical signal path 364 leading back to a micro controller 366. Another electrical line 368 extends between the micro controller and the amplifier 358. In summary, an input signal path is defined by connector 302, paths 312, 310, 313 to connector 304 and is supported by and preferably includes various devices including add/drop 353, circulator 354, amplifier 358, and power monitor 362.

Also shown are optical signal paths 314, 316, and 318 extending from the optical connectors 306, 307 and 308. These signal paths are unidirectional, and are to direct signals from the backplane onto the module. Located in each signal path is a signal selector 350, and after the signal selector 350 the signal paths 306, 307, 308 merge, by means of the combiner 352, into a single signal path 344. Thus along signal path 344 any selected signals from signal selectors 350 carried by the signal paths 314, 316 and 318 will be combined. It can now be understood that optical signals from ports adjacent to other modules in the switch are passed to the module 70 through the connections 306, 307 and 308. The first operation performed is to pass through a signal selector to select and deselect signal components for further signal propagation. This is accomplished by means of signal selectors 350 as shown, which may be of the type shown in FIG. 2. Each signal selector is controlled by electrical control signals emanating from the microprocessor 366 and propagating along input and output electrical control signal paths 370 and 372 respectively. The selected signals are then combined at combiner 352, amplified at amplifier 372, passed to circulator 354, and then passed out of the switch as noted. In summary an output optical path from the module is from connectors 306, 307, and 308 through signal selectors 350 along optical signal paths 314, 316 and 318 through combiner 352, along optical signal path 344, to amplifier 372, then to circulator 354, along optical signal path 310 to add drop 353 along optical signal path 312 and then out connector 302.

A signal channel monitor at 374 is preferably included which relays signal information to the microprocessor 366 as shown, along electrical line 375. Further another power monitor is preferably provided at 376, after the amplifier 372. This power monitor 376 includes an optical input path 377 and an electrical output path 378 to the microprocessor 366. Lastly, if needed or desired a thermal control unit 381, with associated electrical connection 382 to microprocessor 366 may also be included in the module to maintain a desired temperature to ensure operation of the components remains within design parameters. The present invention comprehends other forms of thermal management apart from that being mounted to the expansion module as shown which is provided by way of background only.

It will be understood that the foregoing description is of one design for the switch module of the present invention. Various elements of the foregoing elements may be incorporated onto either the module or the backplane, and some even left out without departing from the spirit of the present invention. The present invention comprehends that the switch module and backplane combine together to form a functional switch device. However it is believed that the maximum advantage will be achieved by placing the most expensive elements onto the switch module, to permit the module to achieve a functionality correlated to the switching need of the particular network node.

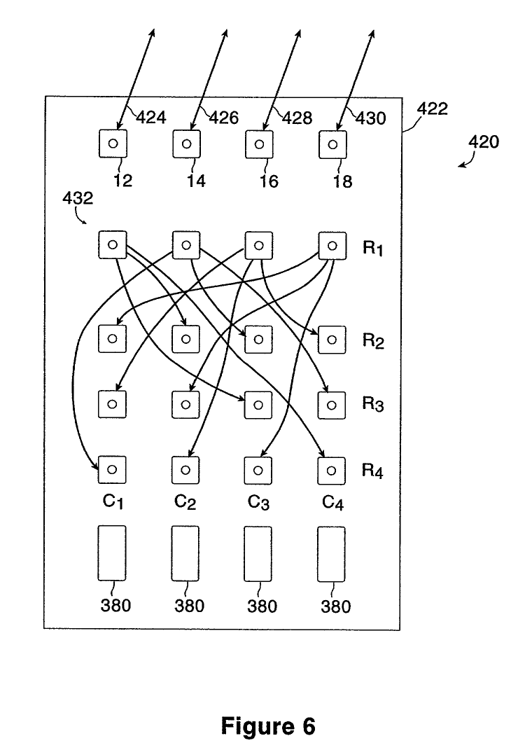

Turning now to FIG. 6 a distributive backplane 420 is shown. The backplane 420 includes a substrate 422 in which a number of signal paths are provided, as well as a number of optical connectors. Along the top edge as shown are located four main input output ports, 12, 14, 16 and 18. Again while this example uses four, more or fewer could be used depending upon the capacity needed in the switch. It will be understood therefore that the present invention comprehends any number of input/output ports. The arrows 424, 426, 428 and 430 represent the bi-directional nature of the signals passing through the input/output ports.

Located below the main input/output ports in FIG. 4 are a set of connectors 432. As shown there are four sets of four connectors 432, which for ease of illustration are shown in four columns C1, C2, C3 and C4. The set of connectors is also organized into rows R1, R2, R3, and R4. Also shown are signal paths between the connectors 432 in the substrate 422. It can now be understood that the ports in R1 differ from the remaining rows in that the signals enter the backplane through R1. Of course any row or column could be used for this purpose and the use of R1 is by way of example only. The signals are then distributed from R1 by means of a splitter, for example, to each and every other column on any row other than R1. Each connector in each column of R1 is connected by means of an optical signal path to at least one other connector in every other column. Thus, for example, the connector at C1R1 has signal distribution paths connecting it to C2R2, to C3R3 and to C4R4. Similarly, C2R1 is connected to C3R2, C4R3 and C1R4, and so on. The present invention comprehends that many different connection arrangements are possible. However, what is desired is to provide the option to deliver each of the signals entering the switch through any given port to every other port through their associated switch expansion module. In some cases it may not be necessary to operatively connect all of the connectors together, if for example the switch has a greater switching capacity than needed at its location within a network. This is explained in more detail below.

The relationship between the switch expansion module of FIG. 5 and the distribution backplane of FIG. 6 can now be understood. The term connector as used herein comprehends any form of connection which permits the optical signal paths to be reliably connected so that signals may pass substantially unimpeded through the connection from one signal path to the next. Most preferably the connector of the present invention will be a plug in type that is readily connected without the need of special tools or the like. The most preferred form of the present invention is to permit the switch module connectors 302, 304, 306, 307 and 308 to be operatively connected to the input/output port 12 and then to C1R1 to C1R4 respectively. Thus, the columns form a connection bay to which a single switch expansion module can be operatively connected. In this sense operatively comprehends such optical and electrical connections as may be needed to ensure the proper function of the combined device.

It will also be noted that the node bus connects to the backplane at receptacles 380. The backplane then may be electrically connected to a separate switch microprocessor or the like for further information processing for the node and for the network as a whole.

The present invention comprehends that at least two switch modules of FIG. 3 are combined with the distributive backplane of FIG. 4 to make a complete switch, with each module docked in its own bay. Thus, depending upon the capacity requirements, more or fewer switch modules can be used, leaving some bays empty for example. The more switch modules that are used the greater the switching capacity for the switch in terms of connecting between ports. As can now be understood the modules of the present invention permit a device which is readily field scalable, simply by adding additional modules to empty bays. Of course such scalability is limited to the size of the backplane originally provisioned and the number of empty bays at any time.

Turning again to FIG. 4 it can now be understood that to complete a four port switch, four expansion modules are required. Thus the ghosted areas on FIG. 1 shown as 70, 72, 74, 76 each correspond to a switch module as shown in FIG. 5. Another advantage of the modules of the present invention is that rather than being custom made for the traffic demands of any specific switching node in a network, each switch expansion module can be made identical. Thus, four port switch modules can be mass-produced which will save on design time, allow for efficiencies in manufacture and reduce the costs of the overall components. The same will hold true for the mass production of the backplanes. Another advantage of the present invention is that the switch modules can be mass produced with different signal switching capacities. Since greater switching capacity generally means an increased number of components and hence cost, allowing the switching capacity of the module to be tuned to the specific traffic for that node in the network provides for a optimization between cost and capacity.

It will be appreciated by those skilled in the art that various modifications can be made to the arrangement of switching components in the present invention as previously described. The most preferred form of the invention is to place the most expensive components onto the switch modules where possible. This permits a switch to be installed with only the needed capacity and with a minimum of components and hence a minimum of expense. However, the invention comprehends other arrangements of elements between the switch module and the backplane. For example, while the switch module 70 (FIG. 5) is shown with the circulator as part of the module, it will be appreciated by those skilled in the art that the circulator could also be mounted to the backplane instead. What the present invention provides is a switch architecture for an all optical switch in which the elements of the switch are separated into a switch module and a backplane for ease of expansion of the switching capabilities and for the simplicity of manufacture.

An issue in switch design is to develop a design with as little power loss and as little expense as possible. As will be understood by those skilled in the art certain of the elements can be very expensive. Utilizing fewer expensive elements in a switch architecture will result in a less expensive switch. Further one that has fewer elements will typically increase the efficiency of the switch by reducing, among other things, power losses or attenuation of the signals as the signals are routed through the switch.

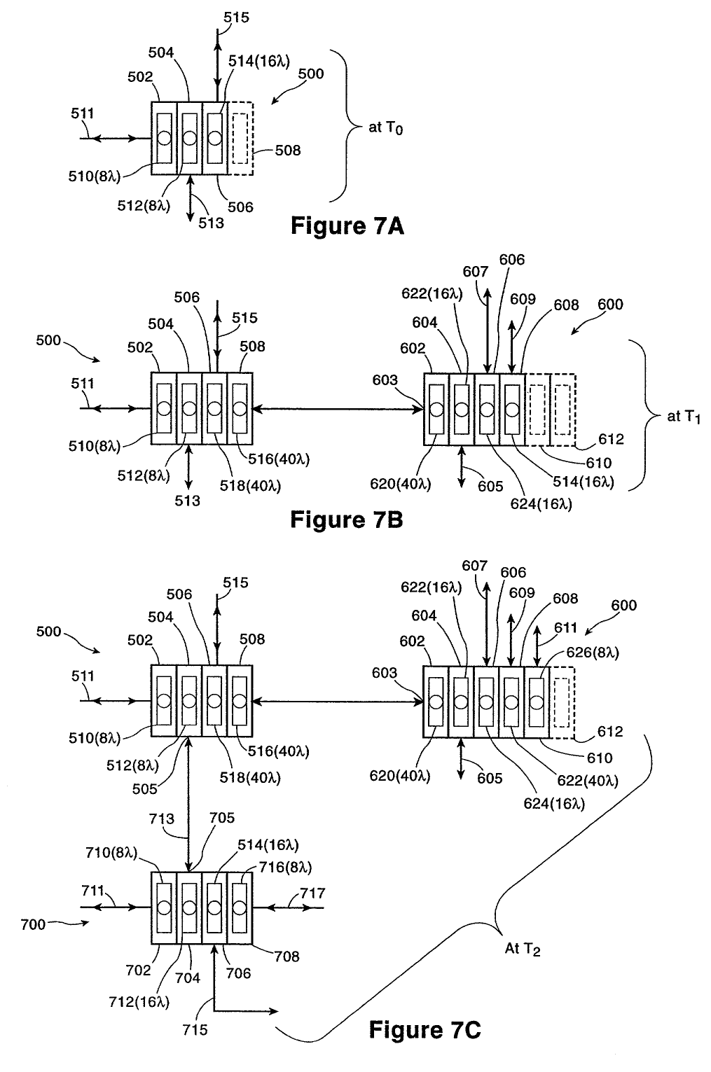

FIG. 7 shows the evolution, over time, of a network utilizing switches of the present invention. Thus, FIG. 7a represent a time TO, FIG. 7b represents a later time T1 and FIG. 7c represents a further later time T2.

In FIG. 7a a four port switch 500 is shown. The switch 500 includes four sections 502, 504, 506 and 508 each of which has a bay capable of docking a switch expansion module therein. Also shown schematically are three switch expansion modules 510, 512, 514, with corresponding adjacent connections 511,513, and 515 to a network. These connections might be to one or more fibres for example. At the early stages of forming a network, not all of the ports may be required, thus, no module is shown docked in the bay in section 508, saving the expense of a switch expansion module.

Further the signal selection capacity of the three switch expansion modules installed may also vary. For example, switch expansion module 514 may allow for individual selection of any of a group of sixteen individual wavelengths while modules 510 and 512 may only select from a group, for example, of a band of eight wavelengths. The wavelength signal selection capacity is indicated in FIG. 7 adjacent to each module.

At time T1 in FIG. 7b, the traffic in the network has increased and there is now a greater need for switching. Thus to accommodate a new node connection to six port switch 600, a new switch expansion module 516 has been inserted into the previously empty bay 508. This module 516 may for example need to switch all signal components, which for the purposes of this example is assumed to be 40 wavelength switching capacity. Also a new module 518 with for example a forty signal component selection capacity has been inserted into the bay on section 506 and the previously positioned module 514 removed.

The connection between switch 500 and switch 600 is made to a port 603 on section 602 of the switch 600, adjacent to switch module 620. This switch module 620 may be a 40 signal component selector. The remaining sections of the switch 600, namely 604, 606, 608, 610 and 612 with adjacent ports 605, 607 and 609 will include switch modules as needed with whatever switching capacity may be needed at that time. By way of example, they are shown as having modules with 16, 16 and 16 signal switching capacities. As shown the module 514 with a 16 signal component switching capacity has now been placed into the bay in section 608. The last two bays 610 and 612 are shown as being empty.

Turning now to FIG. 7c, again due to an increase in traffic, a further switch 700 has been added which has bays 702, 704, 706, and 708. Switch modules 710 (8 wavelengths), 712 (16 wavelengths) and 716 (8 wavelengths) are shown. In addition the signal selection capacity of the sections 608 has been upgraded to a forty signal capacity with a new module 622 and module 514 has been removed. A new 8 wavelength capacity switch module 626 has been added to bay 610 adjacent to port 611. As noted above the removed module 514 is interchangeable into other switches and in fact may be used in the new switch 700. Thus the module 514 that was in bay 608 at T1, is now moved to new bay 706 at T2. As can be appreciated the present invention comprehends increasing the capacity of the switches as the need arises, and the reuse of modules as appropriate.

A further aspect of the present invention can now be understood. One of the current cost constraints in switch design at present is the number of individual wavelengths that can be switched. As noted for each signal band component an individual switch device such as for example a variable optical attenuator (VOA) is required. Thus, a switch that switches individually all forty signal components would require, for example forty VOAs for each signal path. Thus for a four port switch, this means each switch expansion module, having three signal paths, will need three times forty or 120 VOAs. Since there are four cards, a single four port switch will require 480 VOAs, which is expensive, especially if the full signal selecting capacity is not required. Although other switching devices are comprehended by the present invention which may not require such a multiplicity of components, the present invention permits correlating switching capabilities to network demand.

In a typical metropolitan network, what is required is greater signal selection capability the further the switch is away from a terminus from the network. No single terminus connection is likely to require the huge bandwidth that can be delivered by the combination of the signal carrying capacity of the full multiplexed signal. Thus, at the terminals of the network there is less need for signal selection. The coarsest form of signal selection comprises a single selection device to pass or block the full bandwidth of the signal components. A switch expansion module having a single such device for example a VOA will thus be limited to essentially an on or an off position. But a switch having such a capability will only need three VOAs per switch expansion module, which is much less expensive.

Further, as can now be understood, The modular switch architecture of the present invention permits any switch to be upgraded by removing modules having a more limited signal component selection capability and replacing them with modules having a greater signal selection capability. Also, in the event that the network expands, by way of infilling, the modules can be moved to a new node where the specific signal selection capability is most efficiently used, as shown above with the reuse of module 514 between T0, T1 and T2.

It will be appreciated by those skilled in the art that various modifications and alterations can be made to the present invention without departing from the scope of the claims that follow. Some of these variations have been discussed above and others will be apparent to those skilled in the art. For example, while reference has been made to certain switch architectures, other switch architectures are also possible which are also amenable to the modularization as described herein. What is believed important is to provide an architecture which permits the expensive components to be mass produced and selectively installed on switch expansion modules to permit the costs to be correlated to a needed capacity for a switch.

The embodiments of the invention in which an exclusive property of privilege is claimed are defined as follows:

1. An optical switch for routing optical signals, said optical switch comprising:
an optical signal path for routing said optical signals between at least a first port and at least a second port, wherein said optical signal path is divided into two portions,
one portion being defined by at least two switch expansion modules; and
the other portion being defined by an distribution backplane for operatively connecting said switch expansion modules together.

2. An optical switch as claimed in claim 1 wherein said first port is optically connected adjacent to one of said switch expansion modules and said second port is optically connected adjacent to the other of said switch expansion modules.

3. An optical switch as claimed in claim 2 wherein said first and second ports are connected to said distribution backplane.

4. An optical switch as claimed in claim 2 wherein said first and second ports are connected to said at least two switch expansion modules.

5. An optical switch as claimed in claim 3 wherein each of said switch expansion modules comprises:
a first optical path between said adjacent first or second port and said backplane,
an second optical signal path between said backplane and said adjacent first or second port; and
at least one signal selector to selectively select and deselect optical signal components to be carried between said first and second ports.

6. An optical switch as claimed in claim 5 wherein said each of said signal selectors is located on said second optical signal paths.

7. An optical switch s claimed in claim 5 wherein said first optical signal path and said second optical signal path overlap, and wherein a circulator is provided at one end of said overlap.

8. An optical switch as claimed in claim 5 wherein said signal component selector selects individual signal components from said signals.

9. An optical switch as claimed in claim 5 wherein said signal component selector selects groups of signal components from said signals

10. An optical switch as claimed in claim 5 wherein the signal selectors on said modules select different ranges of signal components from other signal selectors on said module.

11. An optical switch as claimed in claim 5 wherein the signal selectors on said modules select the same ranges of signal components from other signal selectors on said module.

12. An optical switch as claimed in claim 5 wherein said first signal path is bi-directional and said switch expansion module includes a means for directing optical signals bi-directionally.

13. An optical switch as claimed in claim 7 wherein said means for directing optical signals bi-directionally comprises a circulator.

14. An optical switch as claimed in claim 1 wherein said distribution backplane accommodates connection to a number of switch expansion module by slots, each slot accommodating one switch expansion module, said number of slots being equal to the number of switch input and output ports.

15. An optical switch as claimed in claim 14 wherein said switch expansion modules include a number of optical connections to said backplane, said number of connections being sufficient to permit a signal received at any given port to be distributed to all other ports.

16. An optical switch as claimed in claim 14 wherein said backplane includes at least one optical signal splitter for splitting optical signal received from any of said switch expansion modules.

17. An optical switch as claimed in claim 16 wherein said optical backplane distributes each of said split signals to at least one optical connection for each other switch expansion module.

18. A switch expansion module for an N port optical switch comprising:
a first optical connector for a main input-output port;
a circulator;
an input-output signal path between the main port and the circulator;
a second optical connector for connecting to a distribution backplane;
a transport signal path from said circulator to said second optical connector;
at least one input connector from said backplane;
a selection optical signal path between said at least one input connector and said circulator; and
at least one wavelength selector associated with said selection optical signal path to select and deselect signal components to pass to said circulator;
wherein said circulator in turn passes said selected signal components from said selector along said input output optical signal path to said main input output port.

19. A distribution backplane for a modular optical switch having N main input/output ports, said distribution backplane comprising:
a plurality of optical connections for optically connecting said backplane to up to N switch expansion modules;
a distribution optical path between each of said input optical connections and N−1 output optical connections, wherein said distribution optical path distributes the optical signal received at any input optical connection to at least one of each of the output optical connections for each other expansion module and each of the up to N switch expansion modules is optically connected through said backplane to all other switch expansion modules.

20. An optical switch for switching optical signals, the switch having N input output ports, said switch comprising:
up to N switch expansion modules, and
a distribution backplane optically connected to said switch expansion modules, said backplane for distributing the optical signals between the switch expansion modules,
wherein each of said switch expansion modules optically connects one of said N input output ports with the distribution backplane and further includes a means for selecting and deselecting signal components from said optical signals for transmission to the input output ports and said distribution backplane optically connects each of said switch plane modules with every other one of said switch plane modules.

21. An optical switching network having optical signal paths which intersect in at least two switch nodes, said network comprising:
at least two switches for switching optical signals, wherein one of said switches is located at each of said switch nodes, each of said switches including at least two switch expansion modules and an optical backplane for connecting the switch expansion modules together, wherein the switch modules from each of said switches are configured to permit said switch modules from either switch to be used interchangeably to complete optical switching in the other.

22. An optical switching network as claimed in claim 21 wherein each said switch expansion modules has a predetermined signal selection capability.

23. An optical switching network as claimed in claim 22 wherein said signal selection capability of said switch expansion modules is the same.

24. An optical switching network as claimed in claim 22 wherein said signal selection capability of said switch expansion module is different from module to module.

25. An optical switching network as claimed in claim 21 wherein said switch expansion modules include an optical signal amplifier for amplifying said optical signals.

26. An optical switching network as claimed in claim 25 wherein said amplification is variable and suits a position of said module in said network.

27. An optical switching network as claimed in claim 16 wherein said switch modules include combiners for combining optical signals received at any one module into a single signal for transportation across the network.

28. An optical switching network as claimed in claim 21 wherein said modules have a port capacity, and each switch has a number of ports, said port capacity of said module being the same as the number of ports on said switch.

29. An optical switching network as claimed in claim 21 wherein said modules have a port capacity, and each switch has a number of ports, said port capacity of said module being different than the number of ports on said switch.

30. An optical switching network as claimed in claim 21 wherein said modules have an optical switching capacity, and are placed in switches in said network at locations having a need for at least that capacity.
